(19) United States
(12) Patent Application Publication
(10) Pub. No.: US 2009/0164782 A1
(43) Pub. Date: Jun. 25, 2009

(54) METHOD AND APPARATUS FOR AUTHENTICATION OF SERVICE APPLICATION PROCESSES IN HIGH AVAILABILITY CLUSTERS

(75) Inventors: Makan Pourzandi, Montreal (CA); Frederic Rossi, Montreal (CA); David Gordon, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/960,058

(22) Filed: Dec. 19, 2007

(51) Int. Cl. H04L 9/00

(52) U.S. Cl. 713/168

(57) ABSTRACT

A method and communication node that for generate a unique service application process biometric identifier for a service application service application process requesting resources and services to another service application service application process in a High Availability (HA) cluster. The method and communication node further authenticate the requesting service application service application process using the unique service application process biometric identifier and thus allowing communication between the first service application process and the second service application process.

### BACKGROUND OF THE INVENTION

1. Field of the Invention

The invention relates to the authentication of service application processes in high availability clusters.

2. Description of the Related Art

A cluster is a set of nodes, each with a unique identifier, connected together by a communication network. The membership of the cluster changes as nodes join and leave the cluster. The Cluster Membership Service allows an application process to retrieve information about the nodes and the membership. It also allows an application process to register to receive notifications of membership changes as they occur, using callback functions. In order to provide failover service and thus High Availability (HA) services, network operators for networks such as computer systems or communication networks having interconnected communication nodes or servers introduce. Such HA clusters operate by having redundant computers or nodes that are used to provide continuous service when system components fail.

For example, the Service Availability™ Forum (SAF) specifications provide high availability service and requirements of service continuity for end-users. Achieving service continuity means maintaining customer data and session state without disruption across switchover or other fault-recovery scenarios. The reader interested in more information relating to the SAF middleware standard specification and HA applications is referred to SAF AIS B 03, which is available at www.saforum.org/specification.

A SAF specifications define the following interfaces for managing Highly Available (HA) applications such as cluster membership, availability, security service, messaging service, event service and others.

Application Interface Specification (AIS): An interface specification that separates the HA applications from the middleware and makes each independent of the other.

Hardware Platform Interface Specification (HPI): An interface specification that separates the hardware from the middleware and makes each independent of the other.

Systems Management Interfaces: Simple Network Management Protocol (SNMP) and Web-based interface that provides distributed monitoring and control access to AIS and HPI.

In a SAF cluster, HA services are distributed across the entire cluster and are provided to HA applications in a transparent manner. This means that communication between applications processes and SAF middleware processes is an attractive target to attackers. For example a process could try to get access to privileged resources reserved to SAF middleware processes.

The security must be enforced on processes belonging to the SAF middleware to protect the integrity of this middleware facing attacks by external applications.

The authentication is traditionally based on ‘Something you know’, such as a password or Personal Identification Number (PIN) on ‘Something you have’, such as hardware token or a private key or on ‘Something you are’, such as a fingerprint, a retinal pattern, or other biometric.

Several authentication solutions exist for Internet and for packet-based networks. In these solutions, the most important step is to be able to authenticate a web server or a web service. That depends on the authentication of the process based on the certificates provided by the application at initialization time. These authentication solutions are based on certificates (for example in optional client authentication in TLS/SSL connections) or based on client's ability to provide the pre-set password. In both cases, this can not be used in SAF clusters when a plurality of processes are created in a dynamic way in different nodes of the clusters. Therefore, still not much has been done to what the process is (“what you are”) or in other words the nature of the process for authentication in distributed systems such as SAF clusters.

Accordingly, it would be desirable to have a solution for authentication of processes in a distributed system which avoids the afore-described problems and drawbacks.

### SUMMARY OF THE INVENTION

It is a broad aspect to provide a method for authenticating a first service application process in a High Availability (HA) cluster of interconnected communication nodes. The method comprises steps for generating a process biometric identifier (PIB) for the first service application process, wherein the PIB is generated using a combination of at least: a service application process identifier (PID) of the first service application process, a cluster identifier (NID) from which the first service application process was created and a start time which is the time from which the first service application process was created. The method further comprises the steps of encrypting the PIB using a secret value, requesting services from the first service application process to a second process, retrieving the encrypted PIB for the first service application process, sending the encrypted PIB from the first service application process to the second process, starting an authentication operation for the first service application process and allowing communication between the first service application process and the second service application process.

It is another broad aspect to provide a communication node in a HA cluster of interconnected communication nodes that comprises an Operating System (OS) for generating a PIB for the first service application process using a combination of at least: a PID of the first service application process, a NID from which the first service application process was created and a start time which is the time from which the first service application process was created.

The OS further encrypts the PIB using a secret value stored at the OS, stores the PIB at the OS; provides the encrypted PIB to a second service application process when the first service application process request services; starts an authentication operation for the first service application process and allows communication between the first service application process and the second service application process.

It is another broad aspect to provide a communication node for authenticating a first service application process in a HA cluster of interconnected communication nodes. The communication node comprises an OS for receiving generating a PIB for the first service application process. The communication node further comprises a second service application process for receiving the encrypted PIB from the first service application process. Following the reception of the PIB, the OS starts an authentication operation for the first service application process and allows communication between the first service application process and the second service application process.

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a cluster of interconnected communication nodes in accordance to the invention;

FIG. 2 illustrates the steps of a method for generating a unique identifier for a service application process in order to authenticated the first service application process in a cluster in accordance to the invention;

FIG. 3 illustrates a list of generated unique identifiers for service application processes in accordance to the invention; and

FIG. 4 is a schematic diagram illustrating a cluster of interconnected communication nodes that comprises multiple secured domains in accordance to the invention.

### DETAILED DESCRIPTION OF THE PREFERRED EMBODIMENTS

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

In order to enforce security of a service application process that requests resources or services to another service application process within the same cluster, there should be provided an apparatus and method for doing so. Since services are distributed across the entire cluster 100 and since they are provided to applications in a transparent manner, exchanges of data between applications processes and SAF middleware processes, which can be any process in High performance computing cluster (HPC) or distributed applications implemented on a cluster like a web server farm that can be hacked by unauthorized processes or applications. For example a process may try to get access to privileged resources reserved to SAF middleware processes. For that reason, whenever a service application process wishes to share resources or request resources from another service application process the requesting or sharing service application process must be authenticated at the requested service application process.

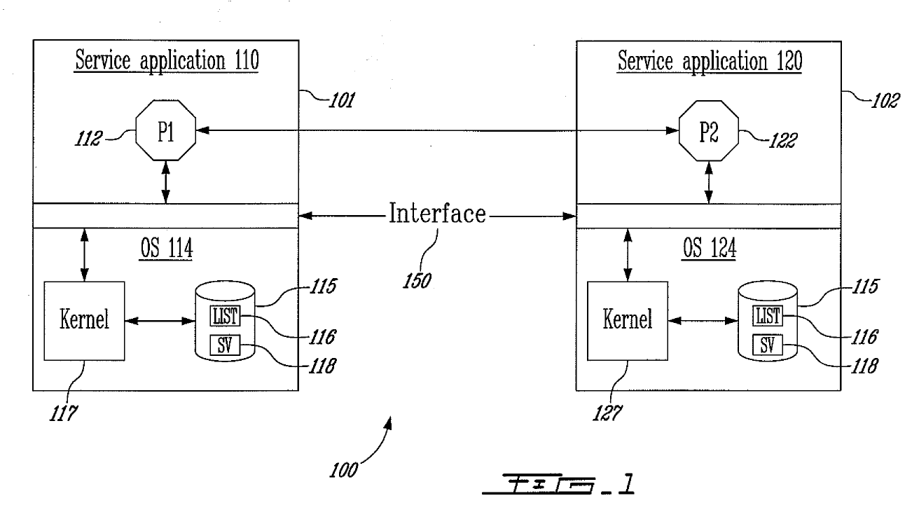

Reference is now made to FIG. 1, which is a schematic diagram illustrating a cluster 100 of distributed communication nodes in accordance to the invention. FIG. 1 gives an example on how access can be provided to a service application process 112, which is part of the service application unit 110 of communication node 101. In FIG. 1, communication node 101 requests resources or services to service application process 122, which is part of service application unit 120 of communication node 102. The cluster 100 can be any distributed network such as a SAF cluster, HPC cluster, Grid cluster, etc. The communication nodes 101 and 102 shown in FIG. 1 may be any communication nodes, computers or servers interconnected for sharing resources in order to provide a service such as database updates or service management for end users in a telecommunication network. An interface 150 operates between the service application 110 and an Operating System (OS) 114 and between the service application 120 and an Operating System (OS) 124. The interface 150 carries message between the service application (e.g. 110 or 120) and the OS (e.g. 114 or 124) for managing HA applications. The cluster 100 of FIG. 1, is not limited to the number of communication nodes shown on FIG. 1, but can be applied to a cluster that comprises more than the number of communication nodes shown on FIG. 1. In the similar line of thoughts, communication nodes 101 and 102 may comprise more then the number of service application processes shown on FIG. 1.

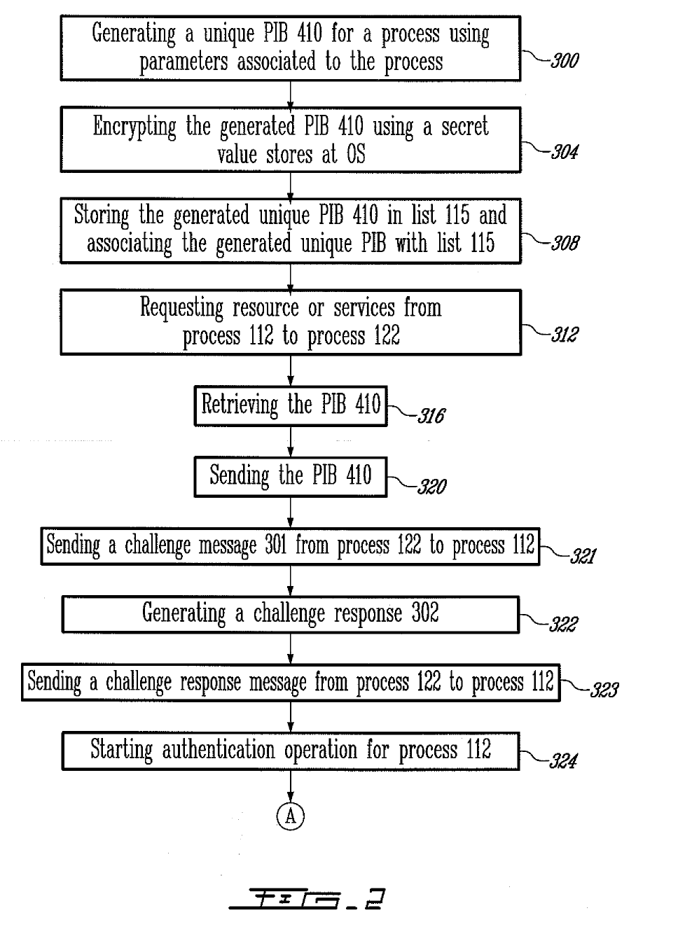

When the service application process 112 is created at the OS 114 level, the OS 114 generates a unique identifier (ID) for identifying and authenticating service application process 112. The unique ID of a requesting service application service application process (e.g. 112) is then used when the service application process 112 requests resources or services to another service application process (e.g. process 122). The unique ID cannot be known by other service application processes and is unique at the same time in the entire cluster. Reference is now made to FIG. 2, which describes a method for generating a unique identifier (ID) for a service application process within a cluster and for providing secured communications between service application processes that belongs to the same cluster in accordance to the invention.

At step 300, a unique ID called a Process Biometric Identifier (PIB) is generated using several parameters. The method is described taking for example the service application process 112 and can be applied to any service application process of the cluster 100. The parameters for generating are, while not being limited to: a process identifier (PID) 402 that identifies the service application process within the communication node 101, a node ID (NID) 403 that uniquely identifies the communication node 101 in the cluster 100 and a Start Time (ST) parameter 404. The pair of node ID (NID) 403 and PID 402 can not define the service application process 112 in a unique way in the cluster 100. For example, the PID 402 may be re-used after the service application process to which it is associated is terminated. The ST parameter 404 avoids the problem related to the re-used PID values over time by the kernel of an OS to reference new service application processes. The ST 404 is defined as the time when a service application process is created based on the number of processor cycles elapsed from boot time of the OS. Since only one service application process PID can be created allocated at time “t” on node NID, the triplet {PID, NID, Start Time} provides the uniqueness of the PIB 410 of a service application process in the cluster 100.

The generated PIB 410 is encrypted (step 304) as follows PIB=enc_sec<PID, NID, StartTime>. The encryption function is performed at the OS 114 and allows encrypting the PIB 410. An algorithm is preferably used for encrypting the PIB 410. This algorithm can be for example a symmetric encryption algorithm like 128 bits algorithm Advanced Encryption Standard (AES) as published by National Institute of Standards and Technology (NIST) as U.S. FIPS PUB 197 (FIPS 197). Different symmetric encryption algorithms can be used given the key size is large enough to provide a reasonable protection like Blowfish as published on www.schneier.com/blowfish.html or 3DES as published and defined in Recommendation for the Triple Data Encryption Algorithm (TDEA) Block Cipher (PDF), Special Publication 800-67. A secret value (SV) 118, which can be of any format (e.g. encryption key) according to the convenience of the application is kept by the kernel 117 in the OS 114 and assigned at configuration time. The SV 118 is used to encrypt the PIB 410. The SV 118 is kept in each kernel's OS (item 117 and 127) memory 115 and is accessible only to the core kernel. The kernel (117 or 127) is the central component of the OS and is responsible for managing the communication node resources and the communication between hardware and software components of the communication node (101 or 102). The SV 118 that is used by each OS to encrypt the PIB is never exported outside of the domain. Some techniques such as TPM or special software artifacts may be used to secure and prevent this SV key 118 to be read by malicious attacker.

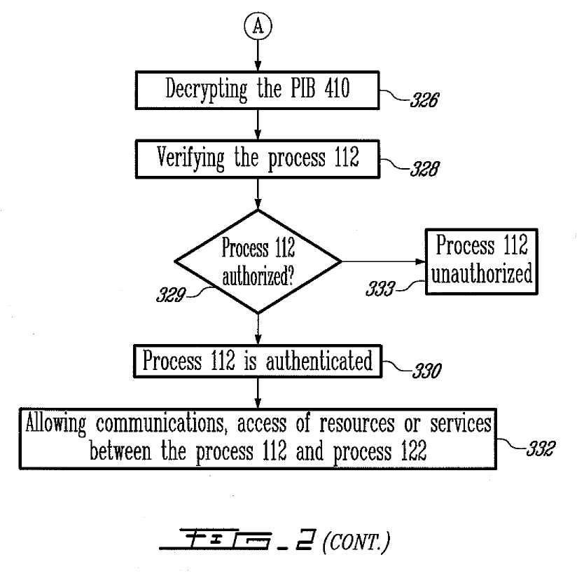

Following the encryption of the PIB 410, the PIB 410 is stored in database 115 (step 308) and is associated to the parameters from which the PIB 410 was generated. The association and storage is better viewed on FIG. 3, which illustrates an exemplary list 116 that may contain generated unique identifiers for service application processes in accordance to the invention. The exemplary list 116 is stored in the database 115. The database 115 can be any persistent memory such as a file system, Flash memory, a static Random Access Memory (static RAM), a Read-Only Memory (ROM), an Electrically Erasable Programmable Read-Only Memory (EEPROM) or a Structured Query Language (SQL) database. The PIB 410 and the associated parameters PID, NID, ST are stored in each node as the service application processes on that node receive the PIB values.

The PIB guarantees that even though the service application process PIB is compromised or stolen, the malicious service application process or eavesdropper can not come up with the right answer to the challenge during any challenge message. Because OS generates the response to challenge based on the PID, NID, and ST of the challenged service application process. The PIB then can be sent to any service application process in the communication node. A service application process which receives this SV 118 can then challenge the requesting (or receiving) service application process to prove its identity.

For example, when the service application process 112 wishes resources or services from service application process 122 (step 312), the service application process 112 retrieves its associated PIB 410 stored in the database 115 (step 316) through a getID message (int bio_getID(bio_ID_t*myID) sent to the OS.

In order to allow services or resources and for authenticating the service application process 112 in the cluster 100 to the service application process 112, the service application process 122 generates a challenge massage, which can be any randomly generated bit array, to the service application process 112 (step 321). When receiving the challenge message 301 the service application process 112 then interrogates the OS 114 for parameters stored in list 116 in order to provide a response to the challenge message 301. The OS 114 then performs a challenge response message 302 for responding to the message 301 and generates a response including the PID 402, the NID 403 and the ST 404 of the service application process 112 (step 322). The OS 114 has the complete control over the service application process 112 and therefore the service application process 112 can not cheat with its PID 402, NID 403, and ST parameter 404. The PID 402 and ST 404 are public parameters that can be easily exported to user space from any service application process on the node. For that reason, the only use of these parameters is not enough to guarantee that the PIB 410 can not be forged. A (SV) 118 is then necessary to encrypt the service application process attributes before they are made visible to other service application processes.

The challenge response 302 can be as follows: chaR=Sha1<cha, PID, NID, ST, SV>. The hash function “Sha1” as defined in Request for Comments (RFC) 3174, published by the Internet Engineering Task Force (IETF) (www.ietf.org), is used as an example here. Thus any hashing function or algorithm, while not being limited to the following, SHA-224, SHA-256, SHA-384, SHA-512, and MD5, as defined in RFCs 4634 and 1321, which are published by the IETF (www.ietf.org), can be used. This response is provided to the service application process 112, which further sends it in the challenge response message 302 to the service application process 122 (step 323). The challenge response 302 is based on PIB ID of service application process 112. Therefore, there is no possibility for any other service application process to get the same challenge message 302 without compromising the OS or without collision, which occurs when a challenge response is provided on purpose from the service application process 112 to a potential attacker.

Upon reception of the challenge response message 302, the authentication operation needs to be performed. Thus, the service application process 122 determines that it needs to decrypt and verify the PIB of the service application process 112 before authenticating the service application process 112 (step 324). The decryption operation and verification operation define the authentication operation of step 324 and are performed at the OS 124.

The OS 124 then decrypts the PIB 410 using the SV 118 (step 326). Following the decryption, the OS 124 verifies that service application process 112 is a valid service application process that is authorized to request services (step 328). The service application process 122 securely requests the running kernel 127 for biometric validation of the PIB 410 of the service application process 112. An exemplary message can be int bio_verify (biot_t bio_B, challenge_t cha, challenge_t chaR). The OS 124 uses the PID 402, NID 403, ST 404 for the peer service application process 112 and computes the value X=Sha1<cha, PID, NID, ST, SV>.

If, at step 329, the X equals the chaR is returned then verification operation determines that the PIB 410 is a valid PIB and the requesting service application process 112 is authenticated (step 330) and can have access to services and network resources (step 332). Thus the authentication is based on what service application process and more particularly on the parameters PID, and ST that are part of the service application process and that cannot be changed for any service application process and not based on what service application process knows or holds. However, if the verification operation determines that the PIB 410 is not valid PIB, the service application process is unauthorized to used resources from the cluster 100 (step 333).

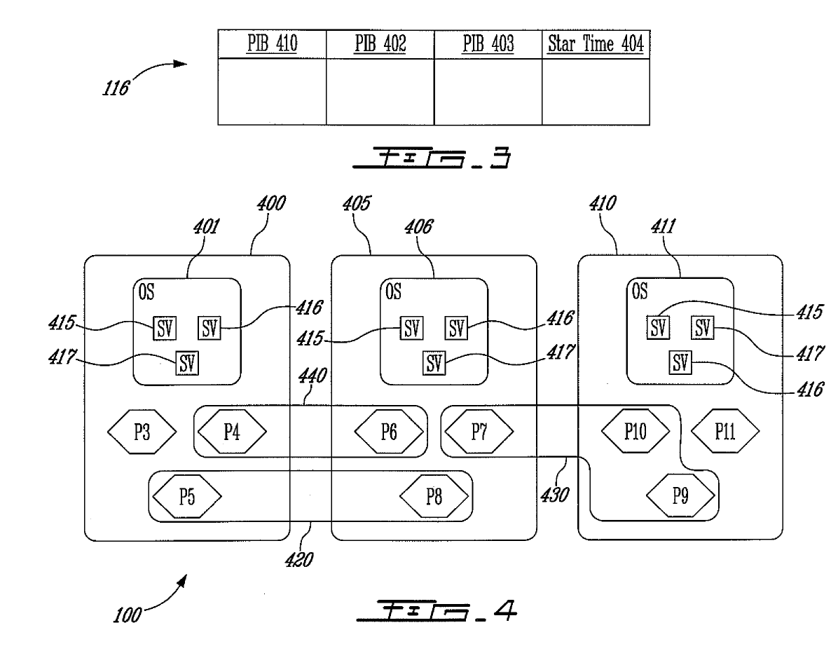

Reference is now made to FIG. 4, which illustrates the cluster 100 that comprises multiple secured domains in accordance to the invention. The cluster 100 of FIG. 4 comprises nodes 400, 405 and 410, which comprise service application processes P3 to P11 respectively. Secured domains 420, 430 and 440 are defined on FIG. 4. A domain may comprise service application processes from different nodes as defined on FIG. 4. Each secured domain may have its own SV 118. The OS is responsible to use the appropriate SV according to which secured domain a service application process belongs to. This then helps creating disjoint, isolated secured domains.

As shown on FIG. 4, there can be more than one secured domain per cluster each having a SV for encrypting a PIB for a service application process of the cluster. Therefore, with collaboration between the two OSes on two different nodes, it is possible to detect forged IDs. For example, the OSes 401, 406 and 411 store a SV that associated for each domain (e.g. SVs 415, 416 and 417) and list the service application processes that are part of a particular domain. The OSes 401, 406 and 411 can also determine which domain a service application process belongs to based on its characteristics such as based on the parameters of a service application process. These different SV 415, 416 and 417 are defined at cluster level and are securely stored in each communication nodes OS in the cluster 100. The OS is on charge of keeping those SVs and never reveals the SVs to service application processes. The SV is used based on which secured domain the service application process belongs to. Then, the PIB generation can be easily extended to support several secured domains.

It can be understood that some messages and therefore some parameters sent between communication nodes of the cluster 100 are omitted for clarity reasons. More particularly, it should also be understood that FIGS. 1 and 4 depict a simplified cluster network 200, and that many other communication nodes have been omitted for clarity reasons only. Hence, the cluster 100 may comprise more than the number of communication nodes present in the Figures. Furthermore, the service application processes and the domains in the cluster 100 are not limited to the number illustrated on FIGS. 1 and 4. The example of the authentication operation for a service application process was described for one service application process. However, it can be understood that many service application processes can simultaneously be authenticated in the cluster 100.

While the invention has been particularly shown and described with reference to the preferred embodiments thereof, it will be understood by those skilled in the art that various alterations may be made therein without departing from the scope of the invention.

What is claimed is:

1. A method for authenticating a first service application process in a High Availability (HA) cluster of interconnected communication nodes, the method comprising:
generating a process biometric identifier (PIB) for the first service application process, wherein the PIB is generated using a combination of at least:
a) a service application process identifier (PID) of the first service application process;
b) a cluster identifier (NID) from which the first service application process was created;
c) a start time which is the time from which the first service application process was created;
encrypting the PIB using a secret value;
requesting services from the first service application process to a second service application process;
retrieving the encrypted PIB for the first service application process;
sending the encrypted PIB from the first service application process to the second service application process;
starting an authentication operation for the first service application process; and
allowing communication between the first service application process and the second service application process.

2. The method of claim 1, wherein the step of encrypting includes the steps of:
encrypting the PIB using an encrypting algorithm; and
storing the PIB in a database of the communication node.

3. The method of claim 1, wherein the step of retrieving includes the step of retrieving the encrypted PIB from a database of the communication node.

4. The method of claim 1, wherein the step of sending includes the steps of:
generating from the second service application process a challenge message for authenticating the first service application process;
sending the challenge message to the first service application process;
generating a challenge response message from the first service application process; and
sending the challenge response message from the first service application process to the second service application process.

5. The method of claim 1, wherein the step of starting the authentication operation includes the steps of:
decrypting the encrypted PIB of the first service application process using a secret value stored in a database of the communication node; and
verifying the PIB of the first service application process using an hashing algorithm; and
determining that the service application process is authorized to receive services in the cluster.

6. The method of claim 1, wherein the first service application process and second service application process are located in a service application of the same communication node.

7. The method of claim 1, wherein the first service application process and second service application process are located in different communication nodes.

8. The method of claim 7, wherein the first service application process and the second service application process are located in the same cluster.

9. The method of claim 7, wherein the first service application process and the second service application process are located in the same domain.

10. The method of claim 7, wherein the first service application process and the second service application process are located in different domain.

11. A communication node in a High Availability (HA) cluster of interconnected, the communication node comprising:
an operating system (OS) for generating a process biometric identifier (PIB) for a first service application process using a combination of at least: a process identifier (PID) of the first service application process, a cluster identifier (NID) from which the first service application process was created and a start time which is the time from which the first service application process was created; and
wherein the OS encrypts the PIB using a secret value, stores the PIB in a database; provides the encrypted PIB to a second service application process when the service application process request services; starts an authentication operation for the first service application process and allows communication between the first service application process and the second service application process.

12. The communication node of claim 11, wherein the first service application process is part of a service application unit of the communication node.

13. The communication node of claim 11, wherein the OS further encrypts the encrypting the PIB using an encrypting algorithm.

14. The communication node of claim 11, wherein the communication node retrieves the encrypted PIB from the database.

15. The communication node of claim 12, wherein the first service application process and second service application process are located in a service application of the same communication node.

16. The communication node of claim 11, wherein the first service application process and second service application process are located in different communication nodes.

17. The communication node of claim 16, wherein the first service application process and the second service application process are located in the same cluster.

18. The communication node of claim 16, wherein the first service application process and the second service application process are located in the same domain.

19. The communication node of claim 11, wherein the first service application process and the second service application process are located in different domain.

20. A communication node for authenticating a first service application process in a High Availability (HA) cluster of interconnected communication nodes, the communication node comprising:
an operating system (OS) for receiving generating a process biometric identifier (PIB) for the first service application process, wherein the PIB is generated using a combination of at least: a service application process identifier (PID) of the first service application process, a cluster identifier (NID) from which the first service application process was created and a start time which is the time from which the first service application process was created;
a second service application process for receiving the encrypted PIB from the first service application process; and
wherein the OS starts an authentication operation for the first service application process and allows communication between the first service application process and the second service application process.

21. The communication node of claim 20, wherein the first service application process is part of a service application unit of the communication node.

22. The communication node of claim 20, wherein the OS decrypts the encrypted PIB of the first service application process using a secret value stored in the database.

23. The communication node of claim 20, wherein the OS verifies the PIB of the first service application process using a hashing algorithm and determines that the first service application process is authorized to receive services from the second service application process in the cluster.

24. The communication node of claim 20, wherein the first service application process and second service application process are located in a service application of the same communication node.

25. The communication node of claim 20, wherein the first service application process and second service application process are located in different communication nodes.
